(19) United States
(12) Patent Application Publication
(10) Pub. No.: US 2005/0278371 A1
(43) Pub. Date: Dec. 15, 2005

(54) Method and system for georeferential blogging, bookmarking a location, and advanced off-board data processing for mobile systems

(76) Inventors: Karsten Funk, Mountain View, CA (US); Yao Meng, Sunnyvale, CA (US); Sharmila Ravula, Mountain View, CA (US); Madhuri Raya, Sunnyvale, CA (US)

Correspondence Address: KENYON & KENYON, ONE BROADWAY, NEW YORK, NY, 10004, US

(21) Appl. No.: 10/869,256

(22) Filed: Jun. 15, 2004

(51) Int. Cl. G06F 7/00

(52) U.S. Cl. 707/102

(57) ABSTRACT

A method and system to bookmark a location, blog geo-referential information, and process the geo referential information, having a mobile device and a stationary server. The mobile device is configured to generate a waypoint to geographically identify the location, generate a timestamp, fetch and store data associated with the location, and receive a user-provided description regarding at least one of the location and the data associated with the location. The stationary server is configured to receive geo-referential information from the mobile device, the geo-referential information including the waypoint, timestamp, and at least one of the data and user-provided description. The server includes a database to maintain the geo-referential information in a spatially and temporally organized manner, and a processing arrangement to adaptively process the geo-referential information according to at least one of a characteristic and preference of a user.

### FIELD OF THE INVENTION

The present invention relates to a method and system for providing geo-referential blogging, bookmarking of a geographic location, and off-board data processing for mobile systems.

### BACKGROUND INFORMATION

A Need to Blog Information Regarding Geographic Locations

Daily life activities, such as obtaining driving directions, planning a trip, checking the weather forecast, and locating a nearby restaurant, may involve interaction with a Geographic Information System (GIS). Such interaction, however, may be considered to be a relatively passive form of information retrieval, so it may be desired to have the further ability to exchange ideas and share experiences.

Online communities, forums, and blogger sites may offer individuals a virtual space to share opinions about geographic information with others. For example, it is understood that a commercial website (e.g., “www.geocaching.com”) may offer a place for people to share experiences of a real world “hide-and-seek” game using GPS (Global Position System) devices. Although the Internet may provide ubiquitous access to miscellaneous geographic information, the ability to link location-intelligent content with open user groups may be lacking. An outdoor activity person, for instance, may have a nice experience with a hiking trail. Even though he/she has marked the trail or waypoints in the GPS device and has taken pictures/notes of the views, it may be inconvenient for him or her to manage or share this information in a geographically organized manner. Online communities and blogger sites may archive such information by time or topic, but as a result, the valuable geographic nature of the information may be left improperly organized or chaotic. Consequently, much of the geographic information may be neglected or wasted because of poor accessibility, and only very little may be exploited by the users. Without a well-defined spatial and temporal reference infrastructure, the gap between information silos of geographic location and a coherent geo-referential system may remain problematic.

It may be desired to have an open community where users can participate in logging personal opinions, knowledge base information, and time-stamped events about any geographic entity, and share experiences based on geo references. It is believed that no single portal or search engine can incorporate the ever-increasing and transient information every day. However, to know something about “somewhere” related to a specified date may be highly desired.

A Need to Remember Geographic Locations

As outdoor activities become more popular so may the acceptance of the Internet as a medium for information retrieval and exchange. More and more people may organize in online communities to exchange information and share experiences. Outdoor activists, such as a hiker, a mountain biker, or a rock climber may use a Global Position System (GPS) device to find and/or mark a trail. In a sport such as fishing, for example, preferred fishing spots may be marked using GPS devices. Even in winter sports, the use of GPS devices may become more popular. In this regard, GPS technology may enable people to later on show and describe their experiences with geographic references, and may also be useful in case of unforeseen circumstances. For example, in case of an accident, a person may provide an exact location of the accident using cell phone. In particular, the person may just call 911, for example, and provide the geographic co-ordinates as delivered by the GPS device thereby saving the trouble of a lengthy search and rescue operation.

GPS devices may offer as a standard a feature to store waypoints. That is, at any geographic location, the user may, by pressing a dedicated button, for example, store the geographic co-ordinates in the device memory. Later on, the stored geographic co-ordinates may be used to find the marked spot again (e.g. for the return path) or the coordinates may be transferred to a computer to relate the marked spot to a map, for example. In this regard, people may post entire GPS traces of their favorite hike on the Internet (GPS traces are the sequential series of retrieved GPS co-ordinates as they were generated by the GPS device every second, for example).

For certain GPS devices, once a waypoint has been set, the user may be required to memorize the meaning of it. For example during a hike, if the user sets a waypoint because of a magnificent view and, later on, sets an additional waypoint for a hike shortcut, and another waypoint for a great picnic spot, the user may be required to memorize which geographic code corresponded to which location.

Limitations of Mobile Devices

As the Internet becomes more wirelessly accessible, the ability to work in a mobile environment may become more feasible. For example, tasks such as real-time inventory checks and online price comparison shopping, that were previously unimaginable, may now become a reality.

Applications that support these tasks may need continuous connectivity to the Internet and/or may require high bandwidth. Such applications may include, for example, audio/video-streaming applications. However, full coverage, high bandwidth, and seamless handover when in motion may not yet be available. Moreover, wireless connectivity may be subject to the capabilities or limits of radio or high frequency transmission technology, which may involve effects that degrade transmission quality or prevent transmission altogether. In particular, the effects may include, for example, fading effects where the signal changes in strength due to environment noise, shadow effects where an obstacle blocks the signal path, and multi-path effects where reflections cause the signals to reach the receiver antenna via different routes and therefore at different times.

If applications require immediate recording and storing, it may be desired to overcome problems associated with spotty wireless connectivity. Moreover, it may be further desired to address problems with applications demanding great computing power on limited devices, including, for example, mobile devices.

Users may desire to store locations, events, thoughts (or whatever the user may want to make a note of) in an easy manner. However, some systems may require intensive user interaction to specify a location, event, or thought. For example, some systems may require user to specify the location, event, or thought by typing or by combined visual and haptic interaction (e.g., menus shown on a touch screen). Although, some systems may offer voice recognition, these systems may additionally require powerful and/or expensive hardware.

### SUMMARY OF THE DISCLOSURE

The exemplary embodiments and/or exemplary methods of the present invention relate to a method and system for geo-referential blogging, bookmarking a geographic location, and off-board data processing for mobile systems.

Geo-Referential Blogging

An exemplary geo-referential blogging server may provide a virtual community repository and access of location-based information in which users exchange geo-referenced information based on their experiences. In this regard, the geo-referential information and a community-based application may be provided to interactively store and share user experiences and/or information about any geographic entity, including, for example, a hiking trail, a point of interest (e.g. restaurant, gas station), a landmark, a road feature (e.g. highway, intersection), or a temporal snapshot (e.g. social event), etc.

A server may establish an open database management system that maintains information in terms of a geo-reference, a timestamp, and/or user-defined criteria. For example, given the geographic coordinates of a particular geographic entity, a user may provide a description using text, audio, images, video or other formatted data, and send the data to the server. The server may store the geo-reference, timestamp, and corresponding information in various formats in a database that manages the data based on a spatial model (according to latitude and longitude), a temporal model (according to a certain time granularity), and/or a structured model (according to particular arrangement or organization of the data, e.g., an arrangement that supports combing a user rating with a particular location or vicinity). In this regard, the information provided to the end user may have a rich data format, including such formats as text, audio, maps (2D and 3D), etc., and the geographic related information may be visualized with a map display for user-friendly operation.

An exemplary server application may “blog” the geo-referenced content from user logs, together with a collection of Geographic Information System (GIS) resources and an aggregation of relevant services such as social event alerts and shopping advisories, thereby forming a self-sustained geographic information repository as well as an interactive user community. The aggregated data, user experience, tidbits of user knowledge, and other seamlessly adapted content may be simultaneously available to other users upon their query.

The geo-referential information may be logged, for example, using a web interface or other suitable graphical user interface (GUI), from a car-based device using a mobile Internet connection (e.g., via a cell phone network or a Wi-Fi hot spot), or from other devices, such as, cell phones or cameras which have location intelligence. The user may be charged based on the information requested from the server. The user may also be awarded for providing input in terms of reviews or information about certain sites, etc.

According to an exemplary embodiment of the present invention, a hiker may want to share his views about a particular hiking trail in a park. Having a personal data assistant (PDA) with a GPS module, the hiker may upload the geographic coordinates of the trail to the server and log certain input about the hike. If another user asks the server application for information about hiking in that area, the server may provide information about that specific hiking trail, as well as the previous user's opinions about the trail. Taking into account the weather forecast in that region, the exemplary server may recommend a preferred date and time to the user.

According to another exemplary embodiment, a first user, upon visiting a restaurant, may wish to provide a review of the restaurant. The first user bookmarks the location of this restaurant from the server's Geographic Information Service (GIS) database and provides an opinion or review of the restaurant. The review information may be presented to a second user asking for driving directions to that restaurant. The second user may also be presented with menu suggestions and parking tips from other users.

According to another exemplary embodiment, a user who is new to a city may ask for a point-of-interest recommendation from the server. Based on the user's personal preference of local events, the user may be provided with a list of locations and timetables. The user may read reviews and feedback from an online user community about the events and make a plan of a day in the city.

Location Bookmarking

An exemplary device according to the present invention may provide an application to integrate a location code in a meaningful way by incorporating a verbal, visual or other input feature. For example, if a “bookmarking” button were pressed, the application may prompt for a voice input to verbally describe a scene or event, or the application may prompt for a visual input such as the taking a picture to visually describe the scene or event. The GPS co-ordinates may also be used as attachments for usage events so that, in this instance, the event may be stored with a geographical reference attached to it.

According to an exemplary embodiment of the present invention, a GPS location component may be integrated in a cell phone, having a bookmarking button that activates a voice memo functionality or initiates a phone call to, for example, a voice portal, which retrieves the GPS code and, based on a speech dialogue, asks for the waypoint description.

According to an exemplary embodiment of the present invention, a GPS location component may be integrated in a camera so that a snapshot, picture, or video taken with the camera may be supplemented with a geographical location. In this regard, it may be easier to pinpoint taken pictures with respect to geographic locations.

According to an exemplary embodiment of the present invention, a GPS location component may be integrated with a wireless device, such as a mobile navigation unit, personal data assistant (PDA), or portable laptop computer so that the user may bookmark points to remember (e.g. restaurants, gas stations, parking locations, etc.) and add a descriptive input to further describe the location. For example, leaving a newly found restaurant, a driver may bookmark this location using a car navigation system that stores a geographical reference and prompts the driver for further descriptions (e.g. via speech). The car navigation system may also send the bookmarked location to a dedicated server.

According to an exemplary embodiment of the present invention, a GPS component may be integrated in an automotive data logger device that performs location bookmarking in a partially or completely automated mode. For example, for maintenance purposes it may be helpful to know the location of an occurrence of critical engine events, such as engine overheating, low oil pressure, etc. Such context knowledge may be useful for scheduling maintenance inspections, for example.

According to an exemplary embodiment of the present invention, a GPS component may be integrated with a camera, a cell phone, a personal data assistant (PDA), an on-board navigation system, a portable computer, and/or other wireless devices. Other combined devices may be provided as well.

According to an exemplary embodiment of the present invention, a GPS location may be integrated into a combined camera and communication device, such as, for example, a device that combines a camera with a wireless phone, in particular, a cell phone with a camera module attached, so that the user may take a picture and send it with the geographical reference. The combined camera and cell phone, and integrated GPS location component, may be useful, for example, for realtors when inspecting a premise. In this regard, the realtor may send images of the premise to the office, whereupon the images may be offered for immediate display. If the integrated GPS location component offers headings (e.g., angle in degree with respect to geographical North), the taken pictures may describe the view with additional directional information. For example, a picture that was taken from the perspective of a certain window of the premise may include the description “This is a view facing West”.

The combined camera, cell phone, and integrated GPS location component may also be useful, for example, for traffic accident reporting and analysis. In this regard, the accident scene may be more precisely described for insurance purposes so that insurance claims may be processed faster and more accurately.

According to an example embodiment of the present invention, people may share their experiences, for example, in online forums. In this regard, the experiences may be shared as geo-referenced information thereby providing an easy way to be as precise as necessary to inform other people and make the experience for others even greater.

According to an exemplary embodiment, bookmarked data may be optionally uploaded. For example, after the data is temporarily stored, the user may be prompted for a decision to upload. If the user agrees, the data is uploaded, for example, either immediately using a cell phone, or later on via a wireless hotspot or a wired network connection. If the user denies upload, the system may store the data internally in long-term memory.

Off-Board Data Processing

The present invention may provide a method and system to retrieve and store data so that the data may be processed at a later time and/or on a more powerful server. In this regard, an exemplary embodiment of the present invention may provide a way to bookmark locations in connection with a mobile system, in order to teach the system personal preferences, such as, for example, a preference for a particular restaurant, landmark, museum, or any other place of interest.

According to an exemplary embodiment of the present invention, a snapshot may be taken of all the context information a system has access to, and complemented with additional information and then stored locally for digital processing at a later stage. In this regard, the process may be triggered by a user command, such as, for example, by issuing a voice command or by pressing a button. Accordingly, an exemplary application may receive the aforementioned snapshot of accessible data, which may include, for example, GPS data, such as geographical co-ordinates, altitude, time, speed and heading (e.g., orientation angle towards North) as well as other data (e.g., automotive data, temperature, pressure, light intensity etc.). Subsequently, a pre-recorded dialog may be initiated, in which additional information (e.g., verbal) may be requested from the user to describe the nature of the location, event, or thought. For example, the user may be first asked to specify a category (e.g. “Location”). Then the user may be asked to provide a sub-category (e.g. “Restaurant”). Thereafter, the user may be asked for more and more specific information or additional input such as a picture (e.g., just taken by an accessible camera) or a sound (e.g., engine noise, bird songs, etc.). The verbal descriptions may be stored as audio files, for example, and the additional data may be stored as video streams, still images, audio files, GPS traces, etc. The user may terminate the dialog using a pre-defined command (e.g., by issuing a voice command, pressing a button, etc.).

According to an exemplary embodiment, if a device running the exemplary application is connected to a dedicated server, a server application may retrieve the data and process it. During the data processing, the server application may input context data into a database (e.g., personal and/or shared location/event/thoughts database) and process stored description files, including, for example, the audio and/or video files generated during a dialog session. In this regard, the audio files generated during the dialog may be processed by a more powerful voice recognition system. Moreover, video streams, still images as well as other sources of data, such as sound may be processed in terms of pattern recognition, face recognition, etc. In this regard, the processing may take place on a central server, where each processing feature may be added without affecting the client. In other words, as soon as a feature such as voice recognition based on Natural Language Understanding (NLU) reaches deployment status, it may be enabled for all devices out in the field. Similar approaches may hold true for face recognition, pattern recognition, sound processing (e.g. sounds from animals, e.g. birds, sound made by weather, structures, engines, etc.).

According to an exemplary method for data retrieval, the system may be initialized by a user-issued command or by an external event. The system may record context data, as they are accessible to the system. After that, the system may prompt iteratively for further descriptive input. Accordingly, the user may provide the requested type of input and the data may be stored in a data package (e.g., compressed and bundled) for later processing.

According to an exemplary method for processing data, once the data processing is initialized, e.g. by uploading the stored information to the processing server, the processing application may extract the data out of a data package, de-compress the data, supplement the data with context data (e.g., GPS data, timestamp, inertial data, etc), and store it in a database. Additional context data may be fetched by the particular mobile device and stored accordingly. The input data may then be processed using, for example, voice recognition, pattern recognition, face recognition, image processing, etc. The results of the processing may be stored in a database.

### BRIEF DESCRIPTION OF THE DRAWINGS

FIG. 1 shows an exemplary system to bookmark a geographic location, perform off-board data processing, and provide geo-referential blogging in a mobile and/or wireless environment.

FIG. 2 shows an exemplary method to blog geo-referential and user-provided data.

FIG. 3 shows an exemplary method to bookmark a location.

FIG. 4 shows an exemplary method to retrieve and store data.

FIG. 5 shows an exemplary method to upload bookmarked data.

FIG. 6 shows an exemplary method to process data in an off-board manner.

### DETAILED DESCRIPTION

System Overview

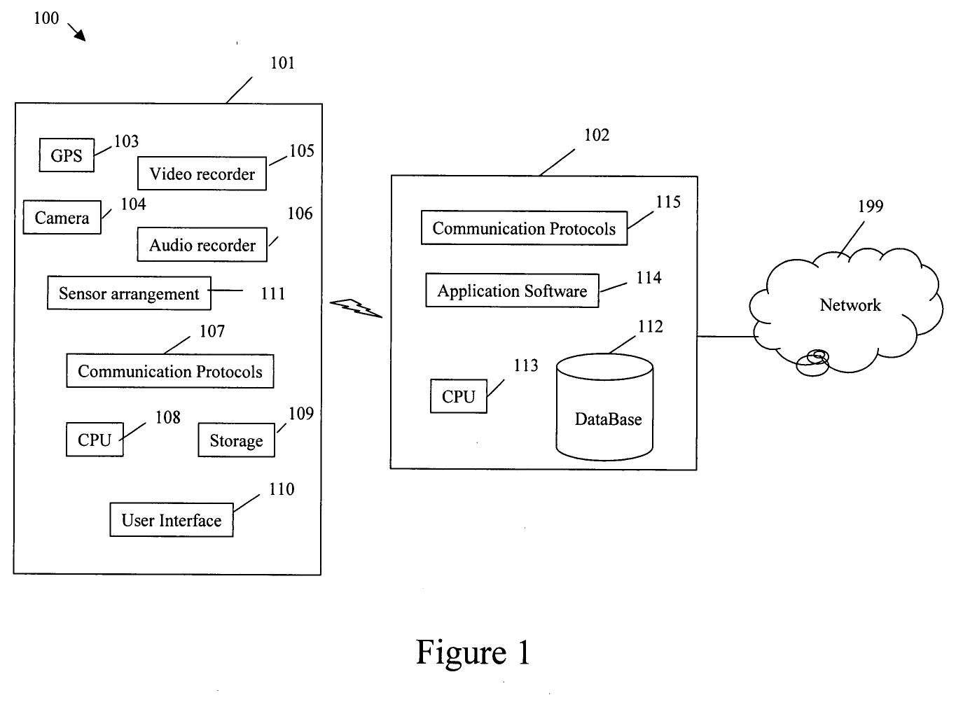

FIG. 1 shows an exemplary system 100 to bookmark a geographic location, perform off-board data processing, and provide geo-referential blogging in a mobile and/or wireless environment. The exemplary system 100 includes a mobile device 101 and a remote server 102. The mobile device 101 may be, for example, a wireless device, a mobile telephone, a personal data assistant (PDA), a portable laptop computer, and/or a navigational device.

The mobile device 101 may include a global positioning system (GPS) 103 to generate geographical coordinates (a.k.a. waypoints), a camera 104 to obtain image content data, a video recorder 105 to obtain video content data, an audio recorder 106 to obtain audio content data, a sensor/measurement arrangement 111 to obtain measurement content data (e.g. soil/water/air examination), an input arrangement or user interface 110 to operate the device and to add user-defined descriptions to the geographical coordinates, a processing arrangement 108 to associate the geographical coordinates with the content data, a local storage arrangement 109 to store the geographical coordinates, user-defined descriptions, and/or content data, and a communication arrangement 107 to communicate with other devices, including the remote server 102.

The remote server 102 may include a database 112 to store the geographical coordinates, user-defined descriptions, and content data, which may be maintained in terms of geo-reference, timestamp, and/or user-defined criteria. The remote server 102 may also include application software 114 to perform post processing of the geographical coordinates, user-defined descriptions, and content data, including for example, processing, such as, for example, voice recognition, pattern recognition, image processing, video processing, data plotting, image generation, document generation, web page generation, email, instant messaging (IM), and/or notification. The remote server 102 may also include a communication arrangement 115 to communicate with the mobile device 101 or other devices/users via, for example, a networked environment 199, such as the Internet. In this regard, the remote server 102 may function as a weblog or “blogging” server allowing users to frequent the server web site to read or browse through weblogs of other users, including users of the mobile device 101. As such, the personal observations, obtained content data, excerpts from other users/sources may be available from a single source.

Geo-Referential Blogging

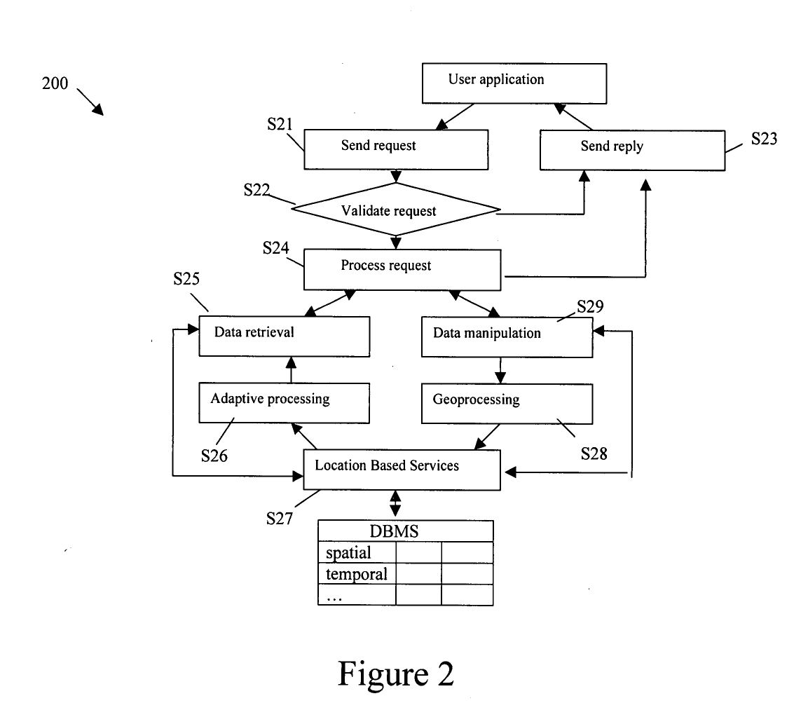

FIG. 2 shows an exemplary method 200 to blog geo-referential and user-provided data. In step S21, a request is sent from a user application. The request may be sent, for example, via a web interface, a WiFi connection, or any other appropriate mobile or wireless interface. The user application may reside, for example, on any device that has a location awareness service, such as a device that has a Global Position System (GPS). Such devices may include, for example, an appropriately equipped personal data assistant (PDA), a portable laptop computer, or in-car navigation device. If the device does not include location awareness services, the user may be requested to supply this information. For example, the user may provide his or her location or his or her destination by supplying a street address. The user application may access Geographic Information System (GIS) information in the form of, for example, map data, a point-of-interest, routing directions, etc.

In step S22, the request is validated. For example, the request may be checked for proper location parameters and/or authorization, including authorization for premium services. The request may be refused if the boundary conditions are not properly met. For example, the request may be refused if a supplied point of interest is not within the scope of services provided (e.g., asking for directions to the moon). The request validation may be performed at least partially by the server.

If the request is not valid then in step S23 a reply is returned to the user application. Otherwise in step S24, the request is processed. During processing of the request the server may, for example, retrieve, manipulate, store, and adapt geo-referential and/or user-provided data (steps S25 through S29).

In steps S25 through S29, data of various formats may be retrieved, stored, manipulated, and adapted in association with a database that manages the data based on spatial, temporal, and/or structured entries. In particular, the various data formats may include text, audio, images, and video, which may be managed in the database according to a geographic location, a time period, a user preferential order, a subjective evaluation criteria, a survey rating, and/or an advisory.

In step S26, adaptive processing is performed which may involve retrieving data from an external source, such as the Internet or other data network, and filtering the retrieved data according to user-supplied geo-referential information and personal preferences of the user. For example, data may be retrieved and filtered from the Internet to determine a gas station with the lowest gas price within a user's neighborhood or within a certain distance from the current location of the user's vehicle or planned route of travel. Data may also be retrieved and filtered to predict an optimum route of travel based on the forecasted weather conditions or other potential traffic-affecting events such as a scheduled sporting or social event. Hence, data may be retrieved and filtered according to a user's personal preferences, including preferences based on cuisine accommodations, personal interests in history, architecture, nature, etc.

The adaptive processing of step S26 may be based on raw data from the user community, or from a third party at cost, or from the server database. The adaptive algorithm may collectively assess all relevant data to provide an appropriate response to the request. For example, a shopping advisory may be supplied to the server from a retailer. The server may forward the shopping advisory to a user based on their profile and user request supplied parameters. The advisory may include information regarding a sales event for a particular item and may be supplemented with additional information supplied by other users within the geo-referential blogging community. The additional information may include, for example, comments and opinion regarding the item for sale and the particular location. The server may use comments and opinions to formulate a collective rating of the sales event or individual comments or opinions may be provided in the response. The information regarding the sales event may be tailored to specific store locations based on, for example, availability of a particular stock item or its size (e.g., clothing size). This may be particularly suitable where certain retail chains have stores of varying size and services, including, for example, retail chains that have flagship stores and outlet stores. A snapshot of the sales promotion event, the type retail store, and its current stock may also be supplied.

The adaptive processing of step S26 may incorporate statistical model techniques and location intelligence. In particular, the server may correlate location, time, user profile, and/or raw data associated with a location and/or a specific time period.

In step S29, data manipulation is performed which may involve adding, deleting, or modifying the data received and/or supplied to the user. In this regard, the data manipulation may be an active, rather than passive process.

In step S28, geo-processing is performed which may involve the determining of a location. The location-based services of step S27 may provide and/or translate the location into a suitable format. For example, the location-based services may translate latitude and longitude coordinates into other alternative descriptions of a location, and vice versa.

Information may be organized in a database based on a geographic reference in the form of, for example, latitude/longitude coordinates. In this regard, the location-based services of step S27 may translate the geographical reference into a more suitable or meaningful form for the user, or alternatively, a user-supplied location into an appropriate geographical reference. For example, the user may supply a street address, a general location with a city, or a landmark, which is translated into a latitude and longitude coordinates via a GPS device.

According to an exemplary embodiment, the information of the database may be organized spatially and temporally. For example, the information of the database may be first organized in a spatial manner according to a geographically referenced location (spatial information as the primary index) and secondly organized in a temporal manner according to a specific time period (temporal information as the secondary index). The information of the database may be further organized according to other criteria as well.

According to an exemplary embodiment, the information of the database may be further organized in a visual manner according to, for example, image or video information, or in an audible manner according to, for example, sound or tonal information. The information of the database may be further organized according to, for example, information regarding a user preferential order, a subjective evaluation, a survey rating, and/or advisories.

According to an exemplary embodiment, the database may be further organized in a transient or non-transient manner according to time. For example, the information may be in the form of “This is the time, and I'm on the X block” or “I am at the X block, at this time, and this additional information”.

According to an exemplary embodiment, the user may capture his location or a nearby landmark and associated data he wishes to share with the blogging community. For example, a bird watcher may encounter a rare species of bird while hiking and may wish to share this experience. In this regard, the bird watcher may capture an image of the bird, record the bird's singing, and download this information to the server along with a geographical reference.

Upon completing the process request, in step S23 a reply is returned to the user application.

Location Bookmarking

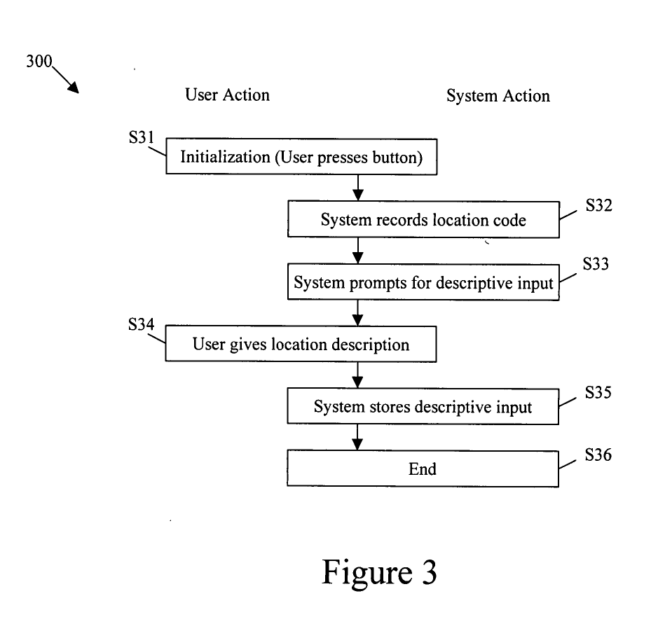

FIG. 3 shows an exemplary method 300 to bookmark a location in the form of a flow chart. In FIG. 3, user actions are represented by boxes that are shown as left justified, and system actions are represented by boxes that are shown as right justified.

In step S31, the user initializes the bookmarking process, for example, by pressing a button. The button may be, for example, a dedicated button provided on a keypad. The initialization process may also be voice-activated or event-driven. For example, the initialization may begin upon the user speaking a certain command (e.g., “Bookmark”), or the initialization may begin upon the taking of picture.

In step S32, the system records the location code. The location code may be, for example, geographical coordinates or a street address, and may be provided, for example, by a GPS integrated component.

In step S33, the system prompts for descriptive input. For example, the system may prompt visually by displaying a message on a visual display screen, or the system may prompt audibly by issuing a tone. The system may also use a combined visual and audible prompt.

In step S34, the user provides a location description. The description may be textual, verbal, visual, or any other communicative or sensory input. For example, the input may be written text, a user's voice, a picture, a video, a sound recording, etc. Moreover, the location description may be provided manually, automatically, or partially automatically. For example, the description may be provided manually by entering text via a keypad, or the description may be provided automatically via the taking of a picture.

In step S35, the system stores descriptive input in a suitable storage arrangement. In step S36, the bookmarking process is ended.

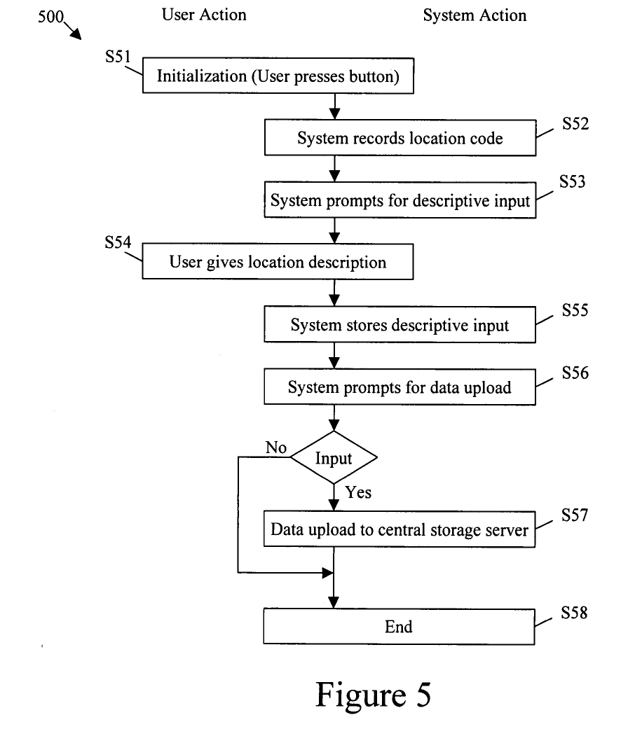

FIG. 5 shows an exemplary method 500 to upload data. In this context, data may refer to any geo-referenced content or geographical co-ordinates with further description. In FIG. 5, user actions are represented by boxes that are shown as left justified, and system actions are represented by boxes that are shown as right justified.

In step S51, the initialization is begun, for example, upon the user pressing a button. The button may be, for example, a dedicated button provided on a keypad. The initialization process may also be voice-activated or event-driven. For example, the initialization may begin upon the user speaking a certain command (e.g., “Bookmark”), or the initialization may begin upon the taking of a picture.

In step S52, the system records the location code. The location code may be, for example, geographical coordinates or a street address, and may be provided, for example, by a GPS integrated component.

In step S53, the system prompts for descriptive input. For example, the system may prompt visually by displaying a message on a visual display screen, or the system may prompt audibly by issuing a tone. The system may also use a combined visual and audible prompt.

In step S54, the user provides a location description. The description may be textual, verbal, visual, or any other communicative or sensory input. For example, the input may be written text, a user's voice, a picture, a video, a sound recording, etc. Moreover, the location description may be provided manually, automatically, or partially automatically. For example, the description may be provided manually by entering text via a keypad, or the description may be provided automatically via the taking of a picture.

In step S55, the system stores the descriptive input. The input may be stored, for example, temporarily, in a suitable storage arrangement so that it may be uploaded at an appropriate time or at the user's discretion.

After the content is temporarily stored, in step S56 the system prompts for an upload decision. If the user agrees, then in step S57 the data is uploaded. The uploading may be immediate when the user device is in reach of a suitable network (e.g., a cell phone), or later when the user device reaches a wireless hotspot or when the device is connected to a network connected device (e.g., a computer). If the user denies upload, the system stores the data internally in long-term memory. In step S58, the process is ended.

Off-Board Data Processing

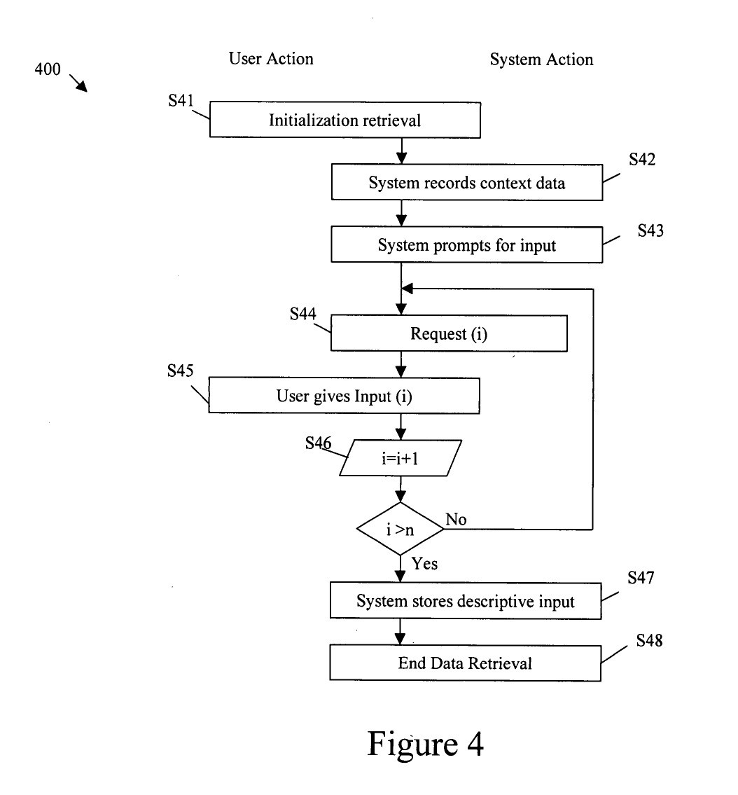

FIG. 4 shows an exemplary method 400 to retrieve data. In FIG. 4, user actions are represented by boxes that are shown as left justified, and system actions are represented by boxes that are shown as right justified.

In step S41, the user issues a command to initialize the retrieval process. The command may be issued, for example, via a voice-activated command using limited on-board voice recognition for Command-And-Control, by pressing a button, by graffiti-based input, or a pre-defined movement, etc. Alternatively, the retrieval process may be initiated by an external event, such as, for example, exceeding or falling below a threshold, etc.

In step S42, the system records context data that is accessible to the system. Context data is data relating to, for example, GPS data, a timestamp, inertial data, etc.

In steps S43 and S44, the system prompts the user for further descriptive input. In this regard, for example, the system may prompt visually by displaying a message on a visual display screen, or the system may prompt audibly by issuing a tone. The system may also use a combined visual and audible prompt. The system may prompt repeatedly in an iterative manner for multiple and/or different types of input.

In step S45, the user provides the requested type of input. For example, the user may provide the requested type of input by issuing a command verbally or pressing a keypad button. The input may include, for example, audio and visual input such as a sound recording or a picture taken from a camera.

In step S46, the number of times the system requests input may be predefined or user-determined. For example, the requesting of data may terminate by reaching a predefined end point or by the issuance of a user command.

In step S47, the data is stored in a data package for later processing. In this regard, the data may be compressed and/or bundled for efficient storage and organization. In step S48, the data retrieval process is ended.

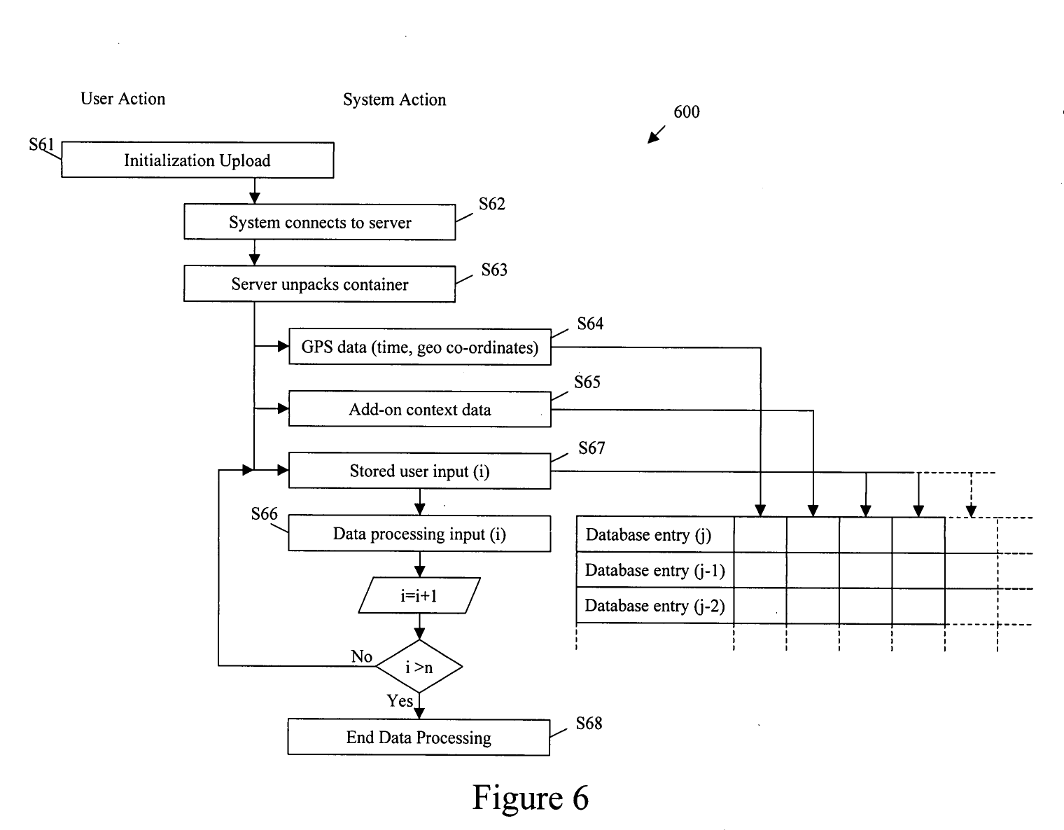

FIG. 6 shows an exemplary method 600 to process data in an off-board manner. In FIG. 6, user actions are represented by boxes that are shown as left justified, and system actions are represented by boxes that are shown as right justified.

In step S61, the stored information is uploaded to the processing server to begin initialization and to start the processing application. In step S62, the system connects to the server 102.

In step S63, the application extracts the data out of the data package and de-compresses the data and additional files. In step S64, the context data, such as, for example, GPS data, a timestamp, and inertial data, are stored in a database. In step S65, any additional context data fetched by the mobile device is stored accordingly. In step S66, the processing of the input data starts. This processing may include, for example, voice recognition, pattern recognition, face recognition, image processing, video processing, data plotting, image generation, document generation, web page generation, email, IM, and notification generation. In step S67, the results of the processing are stored in a database, which may be, for example, the same database used to store the context data. In step S68, the data processing is ended.

According to an example of the exemplary embodiment and/or exemplary method, a hiker may desire to bookmark a landmark. Having a personal data assistant (PDA) with a GPS module, the hiker may start an application, which reads the GPS data and then asks for additional input. The hiker using a Graffiti pen of the PDA supplies the information by filling out a menu based form. The application may request the user to insert a camera module to take a picture of the landmark.

According to an example of the exemplary embodiment and/or exemplary method, a driver may discover a strange sound from the engine compartment while driving. Invoking a built-in car device, the driver may initiate a bookmarking application. After recording the context data (e.g., GPS data, engine status data, etc.) the system may ask the driver to describe the problem or condition that has been encountered. The driver may provide a short summary about the circumstances and then invoke a built-in microphone (e.g. a microphone used for the hands-free cell phone set). The data may be captured, stored, compressed and bundled. When the built-in car device later on connects to a service server (e.g. via W-LAN), the stored data package may be uploaded and processed. A sophisticated sound analysis program may analyze the engine noise and provide advice to the driver or invoke a service call.

According to an example of the exemplary embodiment and/or exemplary method, a hiker may desire to share his hiking experience. An exemplary application, once started, may continually record GPS data to track the trip and, upon user request, store certain information (e.g., verbal, visual, etc.). Later on, a server-based data processing application may de-bundle and de-compress the uploaded package. As part of the processing, the user may choose to have the GPS data representing his trip plotted into a map or satellite image to better visualize the trip. This map or satellite image may include altitude information and calculated statistics (e.g., length, average speed, etc.). The user may also insert clickable annotations providing text, images, sounds, video streams, etc., that are directly or indirectly accessible from the map or satellite image.

1. A method to bookmark a location, to blog geo-referential information, and to process the geo-referential information, the method comprising:
generating a waypoint to identify geographically the location;
generating a timestamp;
fetching and storing data associated with the location;
receiving a user-provided description of at least one of the location and data associated with the location;
communicating geo-referential information from a mobile device to a stationary server, the geo-referential information including the waypoint, the timestamp, and at least one of the data and user-provided description; and
maintaining a database of the geo-referential information in a spatially and temporally organized manner.

2. The method of claim 1, wherein the waypoint includes GPS data.

3. The method of claim 1, wherein the database of geo-referential information is maintained according to a point in time and at least one of a geographical coordinate, an altitude, an orientation, and directional information.

4. The method of claim 1, wherein the user-provided description includes verbal information.

5. The method of claim 1, further comprising:
adaptively processing the geo-referential information according to at least one of a characteristic and a preference of a user; and
maintaining the database of geo-referential information in a structured manner according to the at least one of the characteristic and the preference of the user.

4. The method of claim 5, wherein the characteristic of the user includes a geographic location of the user.

5. The method of claim 5, wherein the preference of the user includes a user rating.

6. The method of claim 5, further comprising:
issuing an advisory to the user.

7. The method of claim 6, wherein the advisory includes a shopping advisory.

8. The method of claim 6, wherein the advisory includes a notice of a social event.

9. The method of claim 6, wherein the advisory includes a warning.

10. A system to bookmark a location, to blog geo-referential information, and to process the geo-referential information, the system comprising:
a mobile device to generate a timestamp and a waypoint that geographically identifies the location, to fetch and store data associated with the location, and to receive a user-provided description regarding at least one of the location and the data associated with the location; and
a stationary server to receive geo-referential information from the mobile device, the geo-referential information including the waypoint, timestamp, and at least one of the data and user-provided description, the server including:
a database to maintain the geo-referential information in a spatially and temporally organized manner; and
an arrangement to adaptively process the geo-referential information according to at least one of a characteristic and a preference of a user.

11. The system of claim 10, wherein the mobile device is a vehicle-based device.

12. The system of claim 10, wherein the mobile device supports a mobile Internet connection.

13. The system of claim 10, wherein the mobile device is configured to store accessible data and prompt a user for additional data input.

14. The system of claim 13, wherein the additional data includes at least one of typed data, graffiti-based input, voice data, sound, images, video, and data streams.

15. The system of claim 13, wherein the mobile device is configured to store the data separately and categorized for later processing on the stationary server.

16. The system of claim 13, wherein the stationary server is configured to perform at least one of voice recognition, pattern recognition, image processing, video processing, data plotting, image generation, document generation, Web page generation, email, IM, and notification generation.

17. A method of blogging geographic information, comprising:
receiving a geo-reference, a timestamp, and user-defined input regarding the geographic information;
storing the geo-reference, the timestamp, and user-defined input in a spatial and temporal reference infrastructure;
adaptively processing the user-defined input according to at least one of a characteristic and a preference of a user; and
providing an open community for users to access and supplement the stored geo-reference, timestamp, and user-defined input regarding the geographic information.

18. The method of claim 17, wherein the step of adaptively processing further comprises:
retrieving data from an external source; and
filtering the retrieved data according to the at least one of the characteristic and the preference of the user.

19. The method of claim 18, wherein the external source includes a networked element.

20. The method of claim 18, wherein the external source includes the Internet.

21. The method of claim 18, wherein the retrieved data is filtered to predict an optimum choice for the user.

22. The method of claim 18, wherein the retrieved data is filtered to predict an optimum route of travel.

23. A system, comprising:
an application to receive geographic-related information from a user, the geographic-related information including a geo-reference and a timestamp;
a database to maintain the geographic-related information in a spatially and temporally organized manner;
an arrangement to process adaptively the geographic-related information according to at least one of a characteristic and a preference of the user; and
a location-based service to provide and translate the geo-reference.

24. The system of claim 23, wherein the geographic-related information further includes user-defined information.

25. The system of claim 23, wherein the geographic-related information further includes at least one of text, audio, images, video data, and sensor readings.

26. A method of integrating data with at least one waypoint, comprising:
generating the at least one waypoint;
providing a description regarding the at least one waypoint upon the generation of the waypoint;
associating the description with the at least one waypoint;
generating content data; and
associating the at least one waypoint with the content data upon the generation of the content data.

27. The method of claim 26, wherein the at least one waypoint identifies at least one of a landmark, a Point-Of-Interest (POI), route specific information, and a personal point-to-remember.

28. The method of claim 26, wherein the at least one waypoint includes geographical coordinates.

29. The method of claim 26, wherein the content data includes at least one of image, video, text, music, sound, voice notes, and measurement data.

30. The method of claim 29, wherein the measurement data includes data related to at least one of soil, water, and air.

31. The method of claim 26, further comprising:
uploading the description and content data to a server.
